(19) United States
(12) Patent Application Publication
(10) Pub. No.: US 2004/0122776 A1
(43) Pub. Date: Jun. 24, 2004

(54) Method for obtaining refunds from a meter that produces a dual postal indicia

(75) Inventor: Ronald P. Sansone, Weston, CT (US)

Correspondence Address: PITNEY BOWES INC., 35 WATERVIEW DRIVE, P.O. BOX 3000, MSC 26-22, SHELTON, CT, 06484-8000, US

(73) Assignee: Pitney Bowes Incorporated, Stamford, CT

(21) Appl. No.: 10/323,205

(22) Filed: Dec. 18, 2002

(51) Int. Cl. G06F 17/60

(52) U.S. Cl. 705/402; 705/14; 705/408

(57) ABSTRACT

A method to create secure postal indicia that is fixed in two or more different mediums, i.e., printed on a mail piece with normal ink and/or invisible ink and recorded in a radio frequency identification (RFID) tag that allows the operator of a dual meter to obtain a postage refund without physically going to a Postal Service office. The foregoing is accomplished by placing a postal value and information in a dual meter archival memory, writing the postal value and information in a postal indicia and recording at the same time the postal value and information in a memory of a RFID tag. The foregoing postal value and information is uploaded to a data center.

### FIELD OF THE INVENTION

The invention relates generally to the field of mailing systems and, more particularly, to meter refund systems.

### BACKGROUND OF THE INVENTION

Governments have created postal services for collecting, sorting and distributing the mail. The postal service typically charges mailers for delivering the mail. Mailers may pay the postal service for this service by purchasing a stamp, i.e., a printed adhesive label or tape, issued by the postal service at specified prices, that is affixed to all letters, parcels or other mail matter to show prepayment of postage. Another means of payment accepted by the postal service is mail that is metered by a postage meter. Postage meters are approved by the postal service and licensed to the meter user by the meter manufacturer. A postage meter is an electromechanical device that maintains, through “electronic registers” or “postal security devices,” an account of all postage printed, and the remaining balance of prepaid postage; and prints postage postmarks (indicia) or provides postage postmarks (indicia) information to a printer, that are printed and accepted by the postal service as evidence of the prepayment of postage.

Currently, mailers are able to use their desktop computer, a postal security device, and a printer to apply postage directly onto envelopes or labels while applying an address. The postage is applied in the form of an Information Based Indicia (IBI). The IBI consists of a two-dimensional bar code containing hundreds of bytes of information about the mail piece (certain human-readable, alpha numeric information). The indicia include a digital signature to preclude the forgery of indicia by unauthorized parties. The postal security device is a unique security device that provides a cryptographic digital signature to the indicia and performs the function of postage meter registers.

In postage meters and computer postage systems, the need for security is absolute, because postage meters and computer postage system are printing value; and, unless security measures are taken, one would be able to print unauthorized postage, i.e., postage for which no payment is made, thereby defrauding the postal service.

Unfortunately, sometimes postage meters and computer postage systems print indicia that are not useable, because the indicia was printed with insufficient ink, the indicia ink smeared, the envelope was damaged, a meter power failure, etc., and the user of the meter or computer postage system wants a refund for the postage that was paid. People also want postage refunds when they decide not to mail the mail piece, i.e., incorrect address, incorrect postage or they changed their mind, etc. To obtain a refund for the postage, the user must return the mail piece to the postal service, which is a time-consuming and labor-intensive process.

### SUMMARY OF THE INVENTION

This invention overcomes the disadvantages of the prior art by utilizing a method to create secure postal indicia that is fixed in two or more different mediums, i.e., printed on a mail piece with normal ink and/or invisible ink and recorded in a radio frequency identification (RFID) tag that allows the operator of a dual meter to obtain a postage refund without physically going to a postal service office. The foregoing is accomplished by placing a postal value and information in a dual meter archival memory, writing the postal value and information in a postal indicia and recording at the same time the postal value and information in a memory of a RFID tag. The foregoing postal value and information is uploaded to a data center.

### BRIEF DESCRIPTION OF THE DRAWINGS

FIG. 1A is a drawing of a mail piece having a prior art digital postal indicia affixed thereto;

FIG. 1B is a drawing of a mail piece having a prior art information based indicia affixed thereto;

FIG. 2A is a drawing of a mail piece having a label with a postal meter indicia printed on the label and a radio frequency identification tag device embedded in the label that is affixed to the mail piece;

FIG. 2B is a drawing of a mail piece having a label with a refunded postal meter indicia printed on the label and a mutilated radio frequency identification tag device embedded in the label that is affixed to the mail piece; FIGS. 3A and 3B are drawings showing the information that is being processed by radio frequency identification tag 15;

FIG. 4 is a block diagram of a dual meter that contains an electronic postage meter, a radio frequency identification tag mutilator, and a radio frequency identification reader/writer;

FIG. 5 is a drawing showing how mail pieces are processed from mail entry office 18 of a carrier to a recipient and how data is captured and distributed; and

FIG. 6 is a drawing of indicia tag usage data center 78.

### DETAILED DESCRIPTION OF THE PREFERRED EMBODIMENT

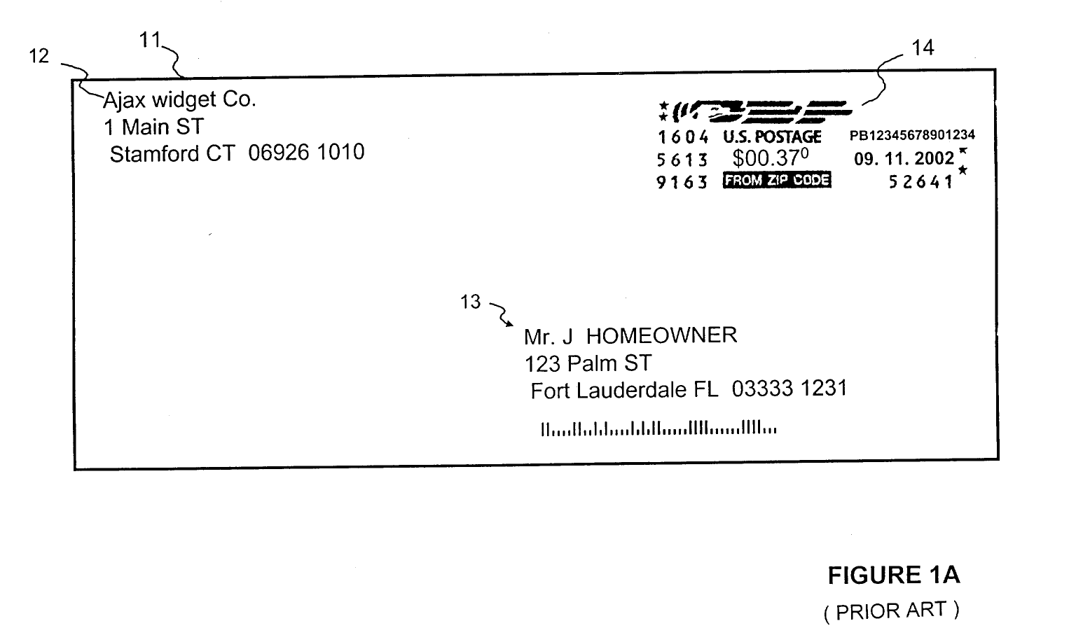

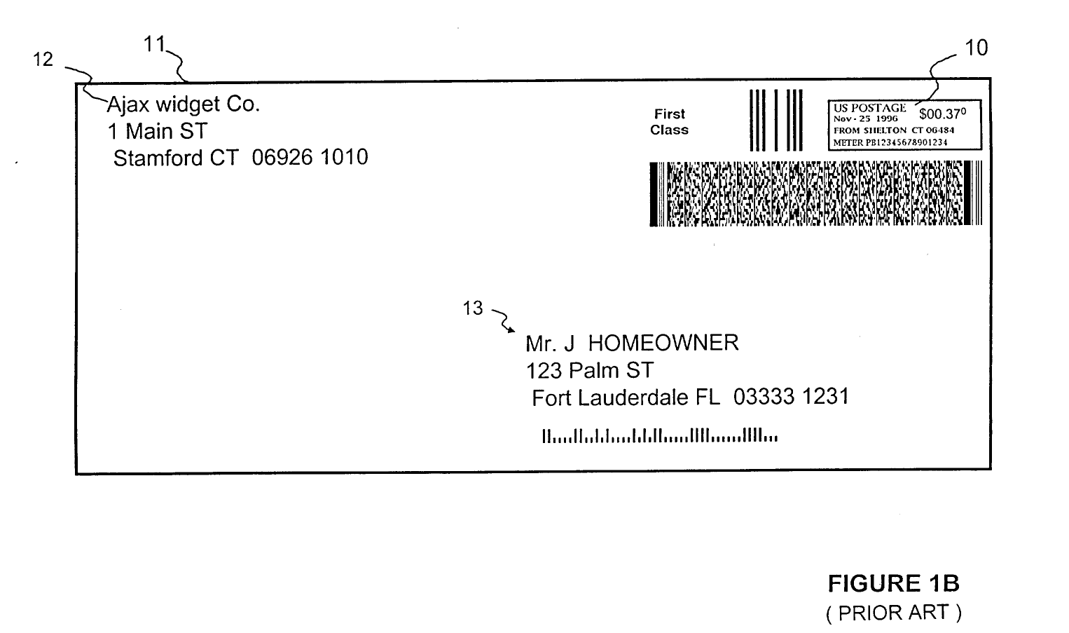

Referring now to the drawings in detail and more particularly to FIG. 1A, the reference character 11 represents a mail piece, i.e., letter, flat, parcel, etc., that has a sender address field 12, a recipient address field 13 and a prior art digital postal indicia 14.

FIG. 1B is a drawing of a mail piece 11 having a prior art information based indicia 10 affixed thereto. Mail piece 11 has a sender address field 12 and a recipient address field 13.

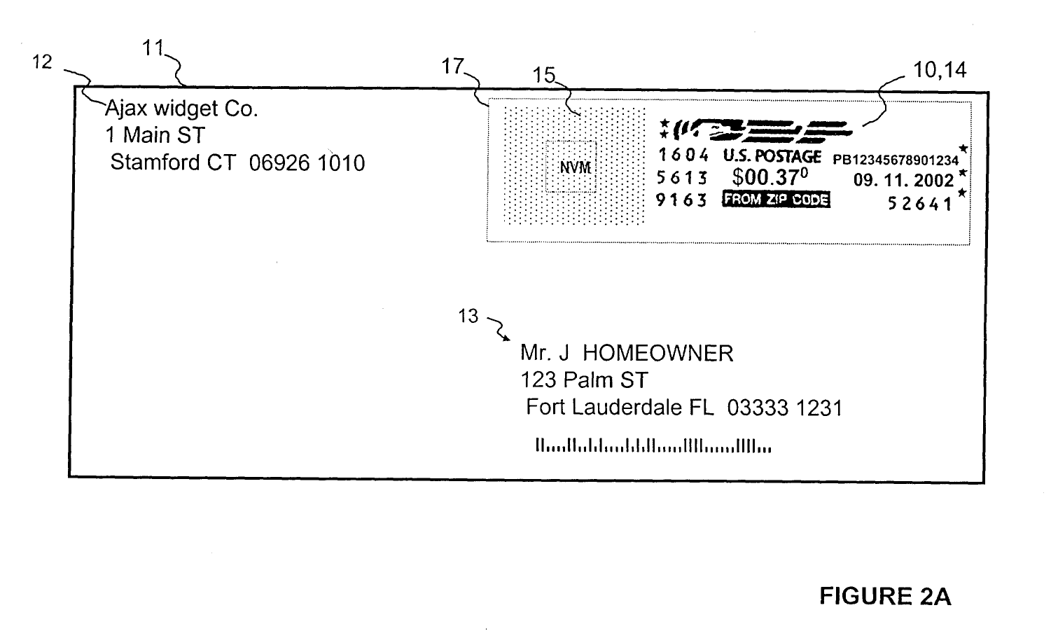

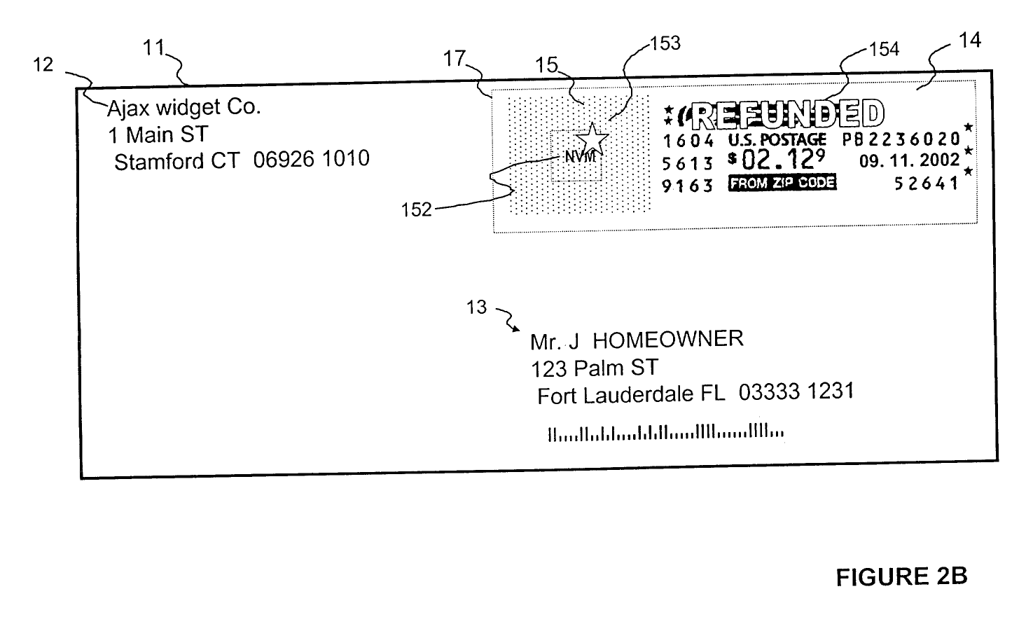

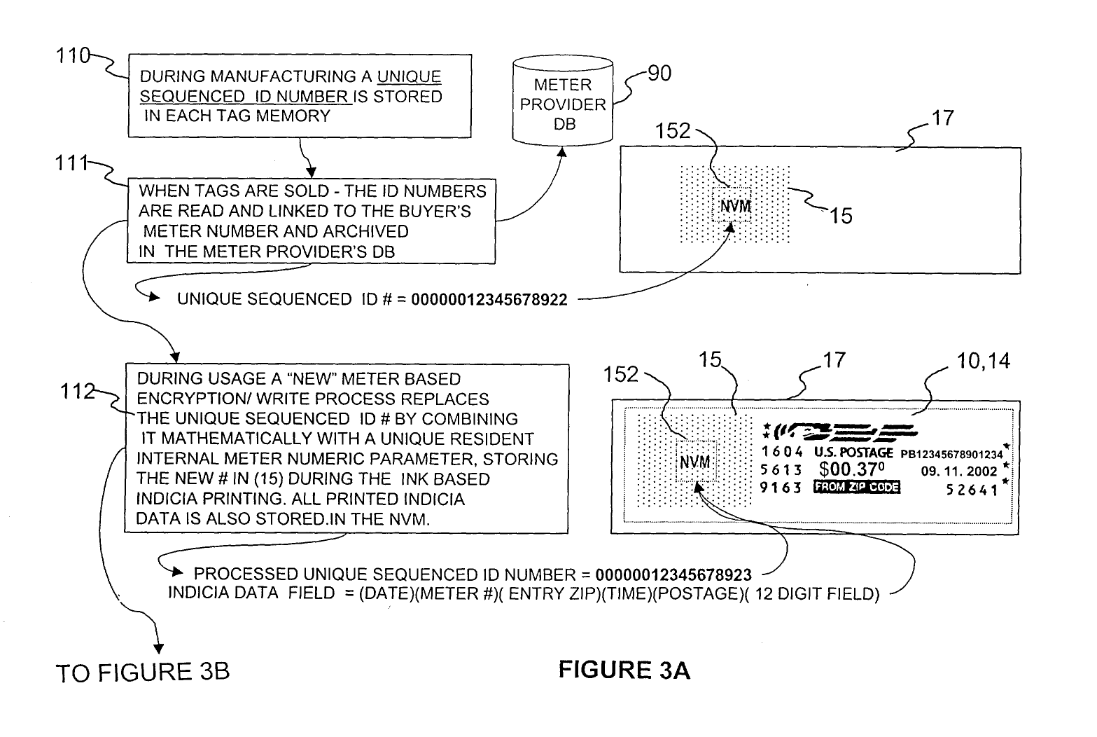

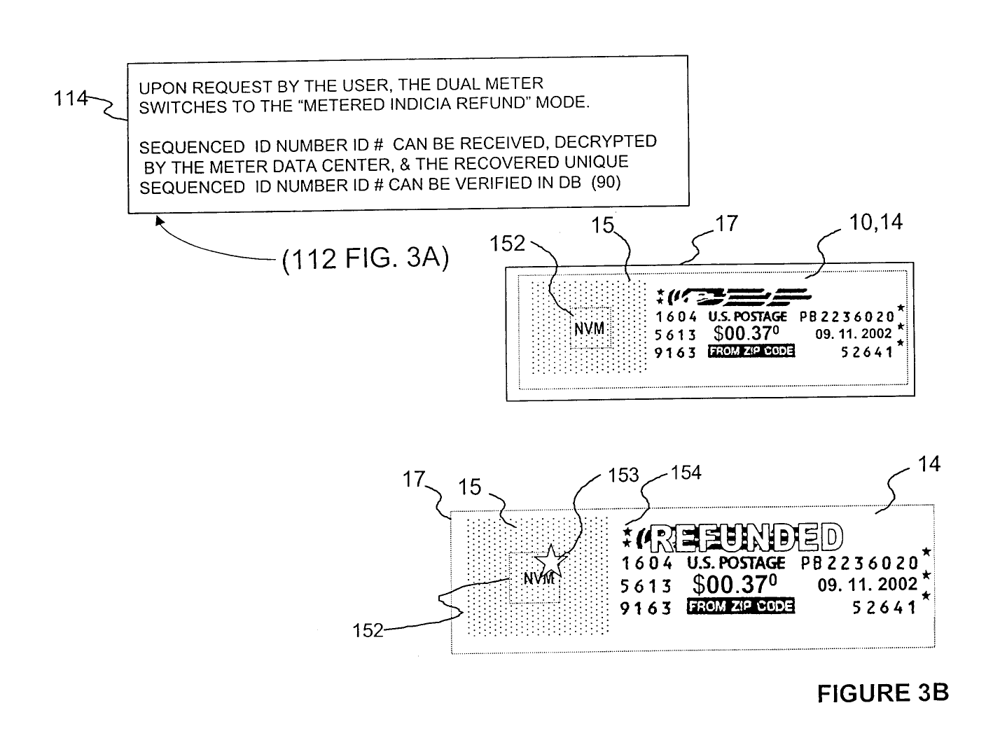

FIG. 2A is a drawing of a mail piece having a label 17 with a postal meter indicia 10 printed on label 17 and an electronic device, i.e., a radio frequency identification tag device 15 embedded in the label that is affixed to the mail piece. Mail piece 11 has a sender address field 12, a recipient address field 13, and a radio frequency identification tag 15 that contains specified information. Postal indicia 14 may be a digital postal indicia or a permit indicia. Information based indicia 10 may be substituted for indicia 14. It would be obvious to one skilled in the art that indicia 10 or 14 may be directly printed on mail piece 11 and tag 15 affixed to mail piece 11 by an adhesive. An invisible ink that may be viewed with an ultraviolet light source such as a red fluorescent or blue fluorescent ink, etc., may be used to print indicia 10 or indicia 14. Radio frequency identification (RFID) tag 15 may be the 4×6 RFID Smart Label Philips manufactured by RAFEC USA of 999 Oakmont Plaza Drive, Suite 200, Westmont, Ill. 60559. The information contained in tag 15 is a unique sequenced identification number that is placed in tag 15 in the factory during the manufacture of tag 15, a number generated by the dual meter using the unique sequenced identification number, the meter number, the date indicia 10 or 14 was affixed to mail piece 11, the time indicia 10 or 14 was affixed to mail piece 11, an entry post office zip code, a 12 digit numeric field contained in the postal indicia, etc.

FIG. 2B is a drawing of a mail piece having a label 17 with a postal meter indicia 10 printed on label 17 and an electronic device, i.e., a radio frequency identification tag device 15 embedded in the label that is affixed to the mail piece. Mail piece 11 has a sender address field 12, a recipient address field 13, and a radio frequency identification tag 15 that contains specified information. Postal indicia 14 may be a digital postal indicia or a permit indicia. Information based indicia 10 may be substituted for indicia 14. It would be obvious to one skilled in the art that indicia 10 or 14 may be directly printed on mail piece 11 and tag 15 affixed to mail piece 11 by an adhesive. An invisible ink that may be viewed with an ultraviolet light source, such as a red fluorescent or blue fluorescent ink, etc., may be used to print indicia 10 or indicia 14. The information contained in nonvolatile memory 152 of tag 15 is a unique sequenced identification number that is placed in tag 15 at the factory during the manufacture of tag 15, a number generated by the dual meter using the unique sequenced identification number, the meter number, the date indicia 10 or 14 was affixed to mail piece 11, the time indicia 10 or 14 was affixed to mail piece 11, an entry post office zip code, a 12 digit numeric field contained in the postal indicia, etc.

When a refund of postage is given for mail piece 11, a star 153 is punched in nonvolatile memory 152 to destroy the information contained in nonvolatile memory 152, and a refunded mark 154 is printed on label 17.

FIGS. 3A and 3B are drawings showing the information that is being processed by radio frequency identification tag 15. Box 110 illustrates that during the manufacture of tag 15, a unique sequenced identification number is stored in each memory of tag 15. Then in box 111, when tag 15 is sold, the identification numbers stored in the memories 152 of tag 15 are read and linked to the buyer's meter number and archived in the meter provider's database 90. The unique sequenced identification number may be 00000012345678922, which is written into the memory 152 of tag 15 of label 17.

Now, in box 112 during usage of the dual meter, a “new” meter-based encryption/write process replaces the unique sequenced identification number by combining it mathematically with a unique resident internal dual meter numeric parameter, storing it in the memory 152 of tag 15 of label 17 during the ink-based indicia printing sequence of the dual meter. A number, i.e., 1, may be added to the unique sequenced identification number to obtain a processed unique sequenced identification number. Thus, the processed unique sequenced identification number will be 00000012345678923. It would be obvious to one skilled in the art that a unique sequenced identification number may be changed to a processed unique sequenced identification number by performing some mathematical function on the unique sequenced identification number, i.e., addition, subtraction, division, multiplication, etc. The data center may also control the changing of a unique sequenced identification number to a processed unique sequenced identification number by encrypting a unique sequenced identification number using a downloaded and updateable encryption key. The meter number, the date indicia 10 or 14 was affixed to mail piece 11, the time indicia 10 or 14 was affixed to mail piece 11, an entry post office zip code, a 12-digit numeric field contained in the postal indicia, etc., are also written into nonvolatile memory 152.

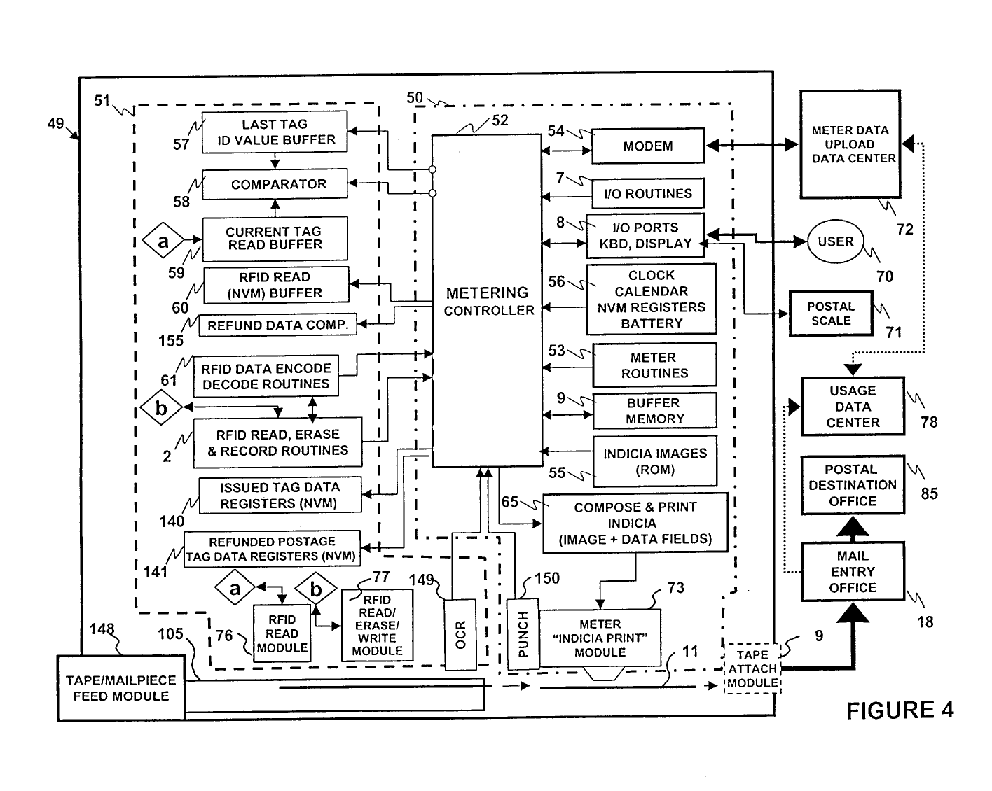

Then in box 114, upon request by the user of dual meter 49, dual meter 49 is switched to the metered indicia refund mode by the placing of a mail piece 11 containing a label 17 in tape/mail piece feed module 148 (FIG. 4).

FIG. 4 is a block diagram of a dual meter 49 that contains electronic postage meter 50, a radio frequency identification reader/writer 51, tape/mail piece feed module 148, OCR reader 149, hole punch 150, and a tape attach module 9. Postage meter 50 may be the B700 Post Perfect postage meter manufactured by Pitney Bowes Inc. of Stamford, Conn.

Metering controller 52 functions as a meter controller for postage meter 50 and a controller for radio frequency identification reader/writer 51. Controller 52 is coupled to last tag identification value buffer 57, comparator 58, current read tag buffer 59, radio frequency identification read nonvolatile memory buffer 60, radio frequency identification encode/decode routines 61, radio frequency identification read, erase and record routine 2, issued tag data registers nonvolatile memory 140, refunded postage tag data registers nonvolatile memory 141, OCR reader 149, and refund data comparator 155. Comparator 58 is coupled to last tag identification buffer 57 and current tag read buffer 59. Buffer 59 is coupled to radio frequency identification read module 76, and radio frequency identification encode/decode routines 61 is coupled to radio frequency identification read, erase and record routine 2. Routines 2 are also coupled to radio frequency identification read/erase/record module 77.

Electronic meter 50 includes meter routines 53, modem 54, indicia image routines read only memory 55, clock calendar nonvolatile memory registers and battery 56, I/O routines 7, I/O ports keyboard and display 8, buffer memory 9 and compose and print indicia image data fields 65 and hole punch 150. Controller 52 is coupled to modem 54, I/O routines 7, meter routines 53, I/O port keyboard and display 8, clock calendar nonvolatile memory registers and battery 56, indicia images 55 and hole punch 150. Compose and print indicia 65 is coupled to meter indicia print module 73 and controller 52.

Meter 50 begins to function when a user 70 sets the postage dollar amount by weighing mail piece 11 (FIG. 1) on scale 71 and enters the type of service for mail piece 11 into I/O ports, keyboard and display 8 of meter 50. The weight and amount of postage for mail piece 11 is displayed by display 8. Controller 52 will compose an image of indicia 10, 14 (FIGS. 1, 2) using the fixed graphic indicia images from indicia images ROM 55 and compose and print indicia images and data field 65. The above image will be stored in buffer memory 9. Buffer memory 9 will provide the above image to meter controller 52.

Meter routines 53 will handle the accounting functions of meter 50. Routines 53 are not being described, because one skilled in the art is aware of their operation and function. Clock calendar nonvolatile memory registers and battery 56 will transmit the date and time to controller 52.

Modem 54 may communicate with meter data upload data center 72 during a refill of postage meter 50 by exchanging funds. User 70 of dual meter 49 communicates with I/O ports keyboard display 8. Postal scale 71 is coupled to I/O ports keyboard display 58 and is used to determine the weight of mail piece 11. Meter data upload data center 72 is coupled to usage data center 78. Office 18 receives mail that has been processed by dual meter 49. Mail flows from office 18 to destination delivery office 85 (currently the USPS has approximately 35,000 mail entry and destination offices). Data center 78 is coupled to mail entry office 18. The images and data fields of indicias 10 and 14 will be transmitted from compose and print indicia 65 to meter indicia print module 73.

Comparator 58 will compare the last tag identification value stored in buffer 57 with the value read by module 76. If comparator 58 determines that the above values are not the same, then tag 15 is a new tag.

Radio frequency identification read buffer 60 is a nonvolatile memory that is used to store the information that is read from tag 15 in case of a power failure, and radio frequency identification encode/decode routines 61 are used to decode the information read from tag 15 and encode data that is going to be recorded in tag 15. Radio frequency identification read, erase and record routine 2 are used to read, erase and record information into tag 15. Issued tag data registers nonvolatile memory 140 stores the information recorded in tag 15, which is uploaded to data center 78 via data center 72.

Tape and feed module 148 contains a stack of labels 105 that include tag 15. Label 17 (FIG. 2B) is transported past radio frequency identification read module 76. Module 76 is positioned in a manner that it will be able to read the information recorded in tags 15 so that module 76 will be able to determine whether or not information has been previously recorded into tag 15. Then label 17 will be transported to module 77 where information will be read, erased and recorded on tag 15. Then label 17 will be transported to paper tape attach module 49. After information is recorded or re-recorded on tag 15, label 17 will be positioned adjacent module 73 so that indicias 10 or 14 may be printed on label 17. Module 49 will affix label 17 to mail piece 11 (FIGS. 1, 2).

When postage meter 50 prints an indicia that is not useable, because the indicia was printed with insufficient ink, the indicia ink smeared, the envelope was damaged, a meter power failure, etc., or the user of the meter wants a refund for the postage that was paid, because they decided not to mail the mail piece, the user obtains a refund through dual meter 49. The foregoing is accomplished by having the user of dual meter 49 insert the mail piece 11 for which a refund is being requested in tape/mail piece feed module 148. Module 148 will transport mail piece 11 with tag 15 attached to label 17 past radio frequency identification read module 76. Module 76 is positioned in a manner that it will be able to read the information recorded in tags 15 so that module 76 will be able to determine whether or not information has been previously recorded into tag 15. Then label 17 will be transported to module 77 where information will be read, erased and recorded on tag 15. OCR reader 149 will read the information printed in indicia 10 or 14. Now comparator 155 will compare the information recorded in tag 15 with the information read from indicia 10 or 14. If the aforementioned information matches and the processed unique sequenced identification number are found in issued tag data register 140, then the value of the refund, i.e., amount of postage, will be stored in refunded postage tag data registers nonvolatile memory 141 for upload to data center 72. Data center 72 will credit dual meter 49 for the amount of refunded postage. If comparator 155 does not find a match, a refund will not be given. Punch 150 will punch a hole in tag 15 to mutilate and destroy tag 15 so that tag 15 may not be reused.

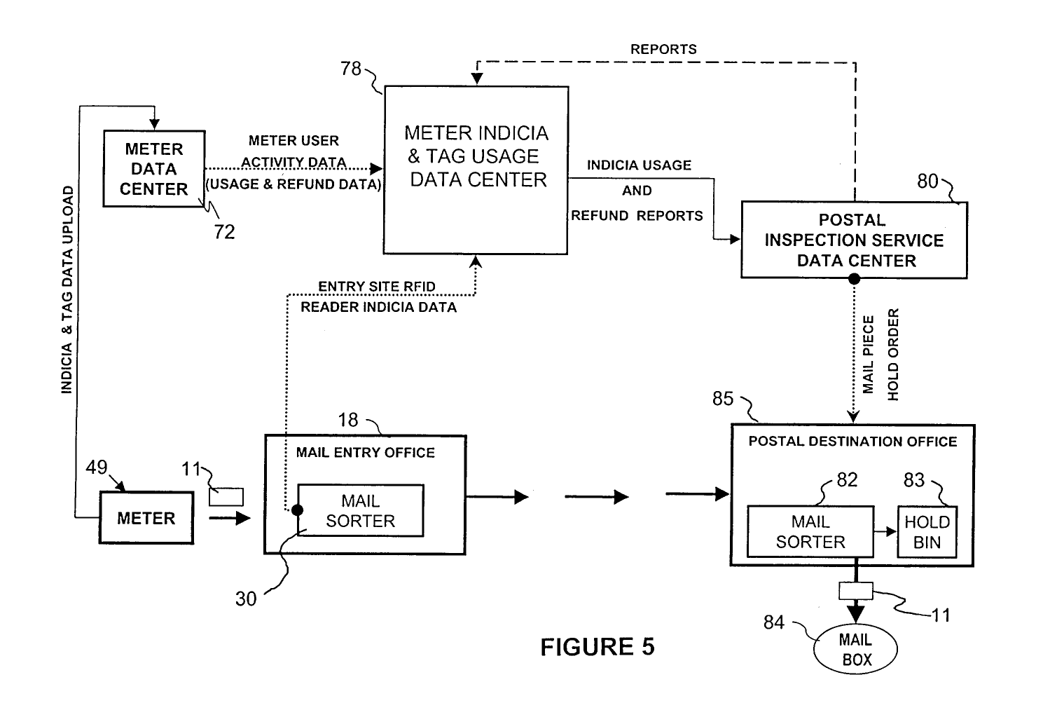

FIG. 5 is a drawing showing how mail is processed from mail entry office 18 of a carrier to a recipient's mail box 84 and how data is captured and distributed. Mail piece 11 that is produced by dual meter 49 enters mail entry office 18 where it is sorted by mail sorter 30. The processed unique sequenced identification number is transmitted to data center 78. The unique sequenced identification number stored in tag 15 at the factory may also be transmitted to data center 78. Data center 78 receives information from mail entry office 18 and meter data center 72, which receives indicia and tag 15 data, i.e., processed unique sequenced identification numbers from meter 49 and/or unique sequenced identification numbers and processed unique sequenced identification numbers from meter 49 and postal values contained in tag 15 and indicia 10 or 14.

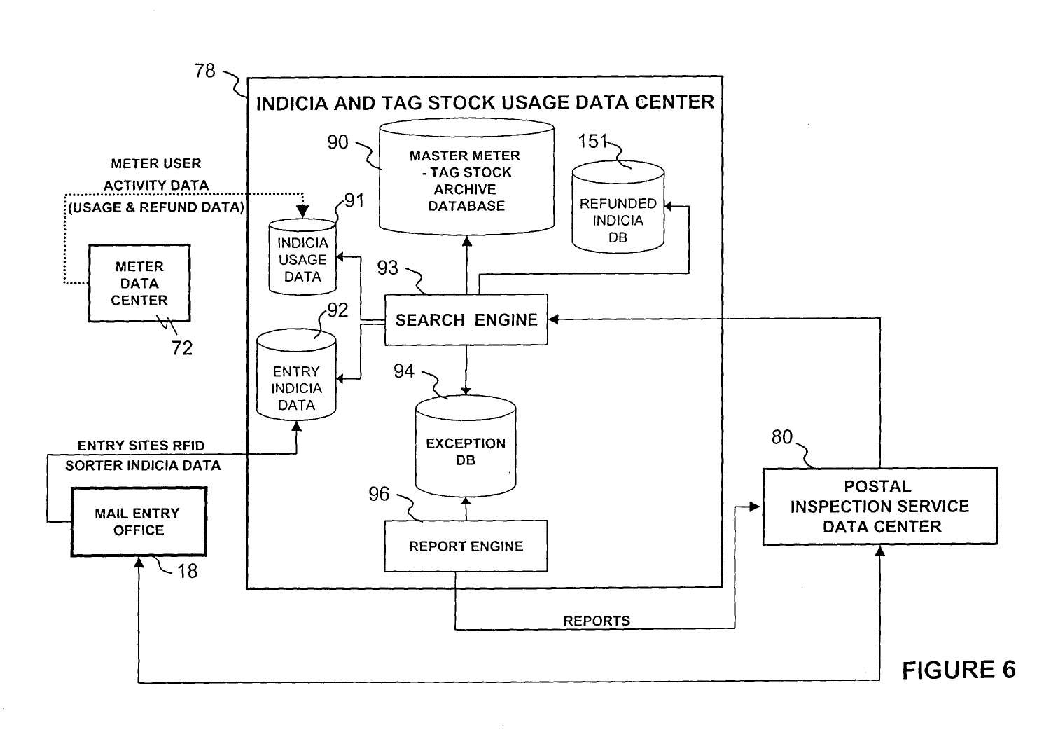

Data center 78 will be more fully described in the description of FIG. 6. Postal inspection service data center 80 is coupled to data center 78 and postal destination office 85. Data center 78 prepares reports that indicate the usage of tags 15 and returned postage for tags 15.

Data center 80 may inform postal destination office 85 of the mail pieces 11 that they want to hold in bin 83. Data center 80 may investigate and/or arrest people who are generating and/or copying fraudulent tags 15. Mail sorter 82 sorts the mail to allow mail piece 11 to be delivered to mail box 84. Data center 80 accepts reports from postal destination office 85 and postal destination office 85 receives mail pieces from mail entry office 18.

FIG. 6 is a drawing of indicia tag usage data center 78. Data center 78 includes master meter tag stock archive database 90, which is coupled to search engine 93 which is coupled to exception database 94 which is coupled to report engine 96, which is coupled to postal inspection service data center 80. Indicia usage database 91 is coupled to search engine 93, meter data center 72 and to entry indicia data 92, which is coupled to mail entry office 18. Refunded indicia database 151 is coupled to search engine 93.

Postal inspection service data center 80 is coupled to search engine 93, reports engine 96 and main entry office 18. Mail entry office 18 is coupled to entry indicia data 92.

Master meter tag stock archive database 90 contains an archived list of the unique sequenced identification numbers stored in the memory of each tag 15, that is linked to the tag buyer's meter number. Indicia usage database 91 receives the identity of dual meter 49, the activity of dual meter 49 and the refunds from data center 72. Entry indicia data 92 receives the information read from tag 15 (FIGS. 1, 2) from mail entry office 18. When search engine 93 is activated, engine 93 reads databases 91 and 92 for mail pieces 11 and examines database 90 for matches, i.e., the information stored in archive 90 should match the information buffered in indicia usage data 91 and entry indicia data 92. In other words, are the unique sequenced identification numbers and the processed unique sequenced identification numbers stored in the memory of tags 15 archived in database 90? When a match is found, the records of archive database 90 record this fact. If a match is not found, an exception is created and stored in exception database 94. If more than one match is detected, one or more copies have been detected, which are stored in exception database 94. Search engine 93 will search indicia usage database 91 and refunded indicia database 151 for duplicate requests for refunds.

Report engine 96 sends reports to data center 80. The aforementioned reports may contain information regarding the suspicious usage of tags 15, i.e., the tags 15 that have the same processed unique sequenced identification numbers and/or the tags 15 that do not have a processed unique sequenced identification number or unique sequenced identification number stored in archived database 90 and tags 15 that have identification numbers that are not associated with a dual meter 49 and tags 15 for which a refund has been previously requested.

The above specification describes a new and improved method for obtaining refunds from a meter that produces dual postal indicia. It is realized that the above description may indicate to those skilled in the art additional ways in which the principles of this invention may be used without departing from the spirit. Therefore, it is intended that this invention be limited only by the scope of the appended claims.

What is claimed is:

1. A method for obtaining refunds from a meter that produces dual postal indicia for mail pieces, said method comprises the steps of:
A. preparing a label that includes a printed postal indicia portion that indicates the amount of postage paid and an electronic device portion having a memory that indicates the amount of postage paid;
B. affixing the label to the exterior face of a mail piece;
C. determining that the mail piece is not going to be mailed; and
D. placing the label in a dual meter to obtain a refund for the postage paid.

2. The method claimed in claim 1, wherein the electronic device is a radio frequency identification tag.

3. The method claimed in claim 1, further including the step of:
mutilating the electronic device to prevent reuse of the electronic device.

4. The method claimed in claim 1, further including the step of:
mutilating the electronic device to indicate a refund of postage.

5. The method claimed in claim 1, further including the steps of:
reading the label to determine the postage;
erasing the postage in the electronic device memory after determining that the mail piece is not going to be mailed.

6. The method claimed in claim 1, wherein the memory of the electronic device stores: a postage meter number.

7. The method claimed in claim 1, wherein the memory of the electronic device stores: the date the indicia is affixed to the label.

8. The method claimed in claim 1, wherein the memory of the electronic device stores: the time the indicia is affixed to the label.

9. The method claimed in claim 1, wherein the memory of the electronic device stores: an entry postal service zip code.

10. The method claimed in claim 1, wherein the memory of the electronic device stores: a numeric code contained in the postal indicia.

11. The method claimed in claim 1, wherein the memory of the electronic device stores: a unique sequenced identification number.

12. The method claimed in claim 1, wherein the memory of the electronic device stores: a processed unique sequenced identification number.

13. The method claimed in claim 1, further including the steps of:
reading the postal indicia portion to determine the amount of postage represented by the indicia;
reading the electronic device portion to determine the amount of postage contained in the memory of the device;
processing a number recorded in the electronic device when the electronic device was produced;
uploading the processed number to a data center;
comparing the amount of postage represented by the indicia with the amount of postage contained in the memory of the device; and
issuing a refund if the amount of postage represented by the indicia matches the amount of postage contained in the memory of the device, and the processed number recorded in the memory of the device matches the number uploaded to the data center.

14. The method claimed in claim 1, further including the step of:
reading the postal indicia portion to determine the amount of postage represented by the indicia;
reading the electronic device portion to determine the amount of postage contained in the memory of the device;
comparing the amount of postage represented by the indicia with the amount of postage contained in the memory of the device; and
issuing a refund if the amount of postage represented by the indicia matches the amount of postage contained in the memory of the device.

15. The method claimed in claim 1, wherein the postal indicia portion of the dual postal indicia is printed on the mail piece.

16. The method claimed in claim 1, wherein the postal indicia portion of the dual postal indicia is printed on a label, and the electronic device portion of the dual postal indicia is affixed to a label that is affixed to a mail piece.

17. The method claimed in claim 1, wherein the postal indicia portion of the dual postal indicia is printed on the mail piece with an invisible ink.
